(19) United States
(12) Patent Application Publication
(10) Pub. No.: US 2026/0169783 A1
(43) Pub. Date: Jun. 18, 2026

(54) CONTAINER LAYER LINEAGE FOR MANAGING SOFTWARE EXECUTION

(71) Applicant: RED HAT, INC., Raleigh, NC (US)

(72) Inventors: Leigh Griffin, Waterford (IE); Andrea Cosentino, Milan (IT)

(21) Appl. No.: 18/984,587

(22) Filed: Dec. 17, 2024

(51) Int. Cl. G06F 9/455

(52) U.S. Cl. CPC G06F 9/45558; G06F 2009/45587

(57) ABSTRACT

Some examples of the present disclosure relate to container layer lineage for software execution. In one particular example, a system can receive a container layer from a repository. The container layer can be associated with first metadata indicating a first hash of the container layer and a first identifier of a first user associated with the container layer. The system can receive a modification to the container layer to generate a modified container layer. In response to receiving the modification, the system can generate second metadata indicating a second hash of the modified container layer and a second identifier of a second user associated with the modified container layer. The system can control use of the modified container layer based on the first metadata and the second metadata.

### TECHNICAL FIELD

The present disclosure relates generally to software execution. More specifically, but not by way of limitation, this disclosure relates to container layer lineage for managing software execution.

### BACKGROUND

Containers are relatively isolated virtual-environments that are typically deployed from image files, which are referred to herein as container images. A container is standard unit of software that packages up code and its dependencies so that the application runs reliably from one computing environment to another. A container image can be a static binary file that includes all of the requirements for running a container. Container images can include a compiled version of a software application as well as system libraries and operating system settings. Individual container images cannot be modified, but if a developer wants to make a change, for example to use an updated version of the compiled software application, the updated software application can be packaged into a new container image with the system libraries and operating system settings. The original container image will remain unchanged.

### BRIEF DESCRIPTION OF THE DRAWINGS

FIG. 1 is a block diagram of an example of a system for container layer lineage for managing software execution according to some examples of the present disclosure.

FIG. 2 is a block diagram of an example of a computing environment for container layer lineage for managing software execution according to some examples of the present disclosure.

FIG. 3 is a flow chart of an example of a process for container layer lineage for managing software execution according to some examples of the present disclosure.

### DETAILED DESCRIPTION

Container layers are typically designed to allow rapid integration and portability, with container layers capable of being pulled from multiple sources and integrated into a container. But, managing lineage and integrity of container layers poses a challenge. As containers are built from container layers, understanding the origin, modifications, and usage trajectory of container layers may be important for ensuring security and reliability of containers. But a container layer conventionally does not include any indication of how the container layer has been modified over time. In addition, a container layer may not include any indication of users that have previously modified the container layer or locations in which the container layer has been stored. So, tracking the changes and interactions to ensure the security and reliability is difficult.

Some examples of the present disclosure can overcome one or more of the abovementioned problems by providing a system that can provide container layer lineage for managing software execution. In an example, the system can receive a container layer from a repository. The container layer is associated with first metadata indicating a first hash of the container layer and a first identifier of a first user associated with the container layer. The system can receive a modification to the container layer to generate a modified container layer. In response to receiving the modification, the system can generate second metadata indicating a second hash of the modified container layer and a second identifier of a second user associated with the modified container layer. As such, a combination of the first metadata and the second metadata corresponds to a lineage of the modified container layer. The system can control use of the modified container layer based on the first metadata and the second metadata. For example, the system can verify whether permissions exist for the second hash or the second identifier to determine whether a container including the modified container layer can be executed. If the permissions exist, the system can execute the container including the modified container layer. If the permissions do not exits, the system can prevent an execution of the container including the modified container layer. In addition, the system can deduplicate storing multiple modified container layers that include the same modification. As such, security and resource consumption for the system is improved.

As a particular example, a container layer may include version 1.7 of Java Development Kit (JDK). The container layer may have been created by user A. So, metadata associated with the container layer includes a first hash indicating the contents of the container layer and a digital signature of user A. A system can receive the container layer and its metadata from a repository. The system can receive a user input from user B to make a modification to the container layer, where the modification involves updating the JDK to version 1.7.1. The system generates metadata associated with the updated container layer, where the metadata includes the first hash and digital signature of user A along with a second hash indicating contents of the updated container layer and a digital signature of user B. The system can then determine whether the updated container layer can be executed based on the metadata. For instance, the system can determine that the digital signature of user B is associated with a trusted user and that the second hash indicates a permitted change for the container layer. So, the system can execute a container that includes the updated container layer. If the permissions do not exist for the digital signature or the hash, the system can prevent execution of a container that includes the updated container layer. Accordingly, the metadata provides a secure and tamper-evident record of each container layer, allowing alterations to be efficiently detected and container layers to be rolled back or prevented from executing when permission violations are detected.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

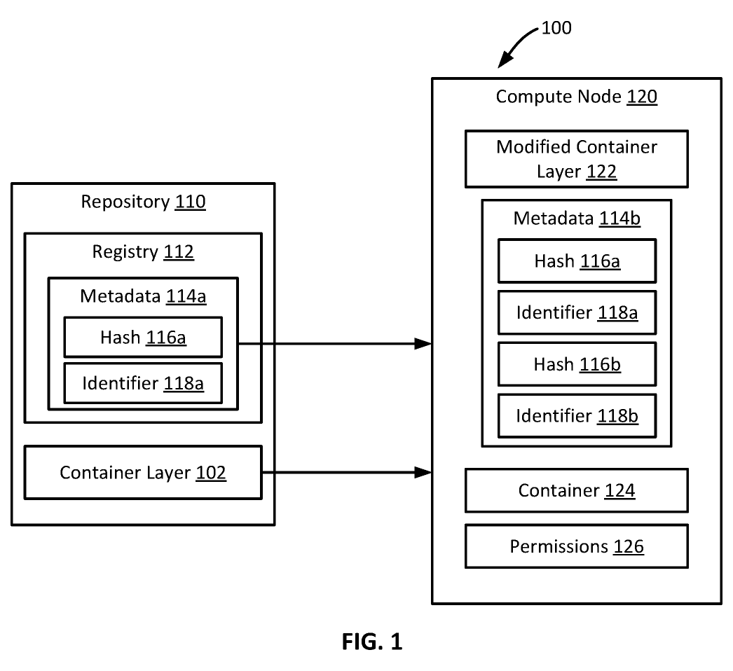

FIG. 1 is a block diagram of an example of a system 100 for container layer lineage for managing software execution according to some examples of the present disclosure. In some examples, the system 100 may be a distributed computing environment such as a cloud computing environment or a computing cluster. The system 100 can be formed from a repository 110 and a compute node 120 that are in communication with one another via a network, such as a local area network (LAN), wide area network (WAN), the Internet, or any combination thereof. Examples of the compute node 120 can include desktop computers, laptop computers, servers, mobile phones, tablets, etc.

In some examples, the compute node 120 can receive a container layer 102 from the repository 110. Containers can include one or more container layers, where each container layer may be pulled from a different source to be integrated into a container. So, the repository 110 is an example of a source from which the container layer 102 is received. The repository 110 can include a registry 112 that stores metadata 114a related to the container layer 102. For example, the metadata 114a can include a hash 116a and an identifier 118a. The hash 116a indicates contents of the container layer 102, while the identifier 118a indicates a user associated with the container layer 102. For instance, the user can be a person who created the container layer 102. The compute node 120 can receive the metadata 114a along with the container layer 102.

Upon receiving the container layer 102, the compute node 120 may receive a modification to the container layer 102. For example, the modification may involve adding, removing, or changing functionality of the container layer 102. As a result of the modification, the compute node 120 can generate a modified container layer 122 that includes the modification. The compute node 120 also generates metadata 114b that is associated with the modified container layer 122. The metadata 114b can include the hash 116a and the identifier 118a that are associated with the container layer 102, along with a hash 116b and an identifier 118b. The hash 116b indicates contents of the modified container layer 122 and the identifier 118b indicates a user associated with the modified container layer 122. The user associated with the modified container layer 122 may be different than the user that is associated with the container layer 102. As such, the identifier 118a can be different than the identifier 118b. In this way, the metadata 114b provides a record of a lineage of the container layer 102 as it is modified.

In some examples, the modified container layer 122 and the metadata 114b may be stored. The compute node 120 may store the modified container layer 122 and the metadata 114b locally. Or, the compute node 120 may store the modified container layer 122 and the metadata 114b in a remote storage location. For example, the compute node 120 may store the modified container layer 122 and the metadata 114b in the repository 110 or in a different repository.

Multiple modifications may be made to a same container layer to generate multiple modified container layers. For example, a first user may provide a user input to the compute node 120 to generate the modified container layer 122 from the container layer 102. A second user may also provide a user input to the compute node 120 or a different device to generate another modified container layer from the container layer 102. Each of the modified container layers are associated with metadata indicating an identifier the respective user that provided the user input as well as a hash of the respective modified container layer.

In some examples, upon generating the metadata 114b, the compute node 120 can determine whether a same modified container layer already exists in a storage location. For instance, the compute node 120 can compare the hash 116b in the metadata 114b to the hash of the other modified container layer. If there is a match between the hashes, even if the identifiers do not match, the compute node 120 can determine that a container layer with the same modification as the modified container layer 122 already exists. So, the compute node 120 can deduplicate storage of the modified container layers. For example, if the other modified container layer is already stored in a storage location, the compute node 120 may forgo storing the modified container layer 122, and instead may store a reference to the other modified container layer. In addition, if the hashes are different, the compute node 120 can store both modified container layers and their associated metadata.

In some examples, the compute node 120 can control use of the modified container layer 122 based on the metadata 114a and the metadata 114b. Controlling use of the modified container layer 122 can involve causing or preventing execution of a container 124 that includes the modified container layer 122. For example, the compute node 120 may include permissions 126 indicating rules for using the modified container layer 122 in the execution of the container 124. The compute node 120 can determine whether the permissions 126 include a permission to use the modified container layer 122 based on the identifier 118b. For instance, the permissions 126 may include a list of trusted users for which containers can include container layers created or modified by the trusted users. So, if the list of trusted users in the permissions 126 includes the user associated with the identifier 118b, then the compute node 120 can determine that the modified container layer 122 can be used in the execution of the container 124.

Alternatively, if the list of trusted users in the permissions 126 lacks the user associated with the identifier 118b, then the compute node 120 can determine that the modified container layer 122 cannot be used in the execution of the container 124. In this case, the compute node 120 may determine whether the user associated with the identifier 118a is included in the list of trusted users of the permissions 126. If the permission exists for the user associated with the identifier 118a, then the compute node 120 can execute the container 124 using the container layer 102. To do so, the compute node 120 can rollback the modified container layer 122 to the container layer 102 and use the container layer 102 in the execution of the container 124.

In some examples, the permissions 126 may also indicate permissions for using the modified container layer 122 based on the contents of the modified container layer 122. That is, the compute node 120 can determine whether the permissions 126 include a permission to use the modified container layer 122 based on the hash 116b. If the permission exists, the compute node 120 can control the use of the modified container layer 122 by executing the container 124 that includes the modified container layer 122. If the permissions 126 lack the permission for using the modified container layer 122 based on the hash 116b, then the compute node 120 can determine that the modified container layer 122 cannot be used in the execution of the container 124. In this case, the compute node 120 may determine whether the container layer 102 has a permission for being executed based on the hash 116a. If the permission exists for the hash 116a, then the compute node 120 can execute the container 124 using the container layer 102. To do so, the compute node 120 can rollback the modified container layer 122 to the container layer 102 and use the container layer 102 in the execution of the container 124.

Evaluating the hash 116b for the permissions 126 may involve determining a type of the modification based on the hash 116b. For example, the hash 116b may indicate that the modification involved an upgrade from one version of a software application to another version of the software application. The permissions 126 can indicate whether executing the modified container layer 122 having the updated version of the software application is permitted for the compute node 120. If so, the compute node 120 can execute the container 124 having the modified container layer 122. Otherwise, the compute node 120 can prevent the execution of the container 124 using the modified container layer 122. Rather, the compute node 120 may execute the container 124 having the container layer 102. For example, the permission may exist for the hash 116b indicating that the modification involved the upgrade from one version of the software application to another version of the software application. But, a permission may be lacking if the hash 116b indicates that the modification involved a complete software application or environment change (e.g., a change for Java Development Kit (JDK) from OpenJDK to Oracle JDK). So, based on the type of the modification, the compute node 120 can control the use of the modified container layer 122.

In some examples, metadata may also be stored for a container that includes multiple container layers. The container can have its own hash and user identifier in the metadata. So, the permissions 126 may additionally include permissions at a container-level. That is, even if each container layer (or modified container layer) that is included in a container is identifier and hash compliant, meaning the permissions 126 include permissions for using the container layer or modified container layer based on the respective identifiers and hashes, the permissions 126 may lack a permission for executing the overall container. As an example, because container layers are included in a container in a particular order, the order of the container layers affect the hash of the container. So, the hashes for the container layers may be permission-compliant, but the overall hash may lack a permission if the order of the container layers in the container are prohibited. For example, a container having ten container layers numbered one through ten and in sequential order (e.g., one to ten) in the container can have a hash for which a permission exists in the permissions 126, meaning that the container having the container layers in the order one to ten can be executed by the compute node 120. But, a container having the ten container layers with container layers out of sequential order, such as in the order of one, two, three, four, six, five, seven, eight, nine ten, where container layers five and six are flipped, can have a hash for which the permissions 126 lack a permission. So, the container having the container layers out of order can be prevented for execution by the compute node 120.

While FIG. 1 depicts a specific arrangement of components, other examples can include more components, fewer components, different components, or a different arrangement of the components shown in FIG. 1. For instance, while FIG. 1 only shows one repository storing a container layer, other examples may include a different number of repositories storing different numbers of container layers. Also, any component or combination of components depicted in FIG. 1 can be used to implement the process(es) described herein.

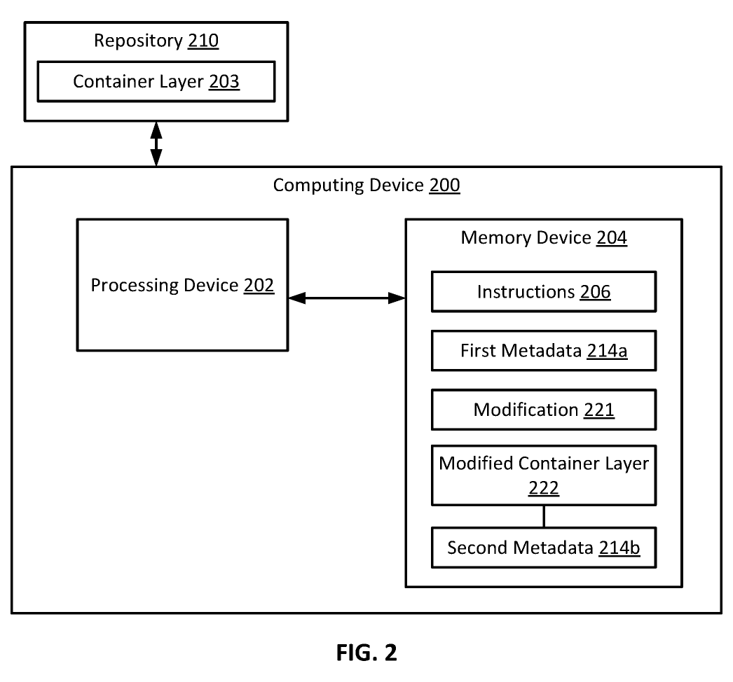

FIG. 2 is a block diagram of an example of a computing device 200 for container layer lineage for managing software execution according to some examples of the present disclosure. The computing device 200 includes a processing device 202 communicatively coupled to a memory device 204. In some examples, the components of the computing device 200, such as the processing device 202 and the memory device 204, may be part of a same computing device, such as the compute node 120 in FIG. 1. In other examples, the processing device 202 and the memory device 204 can be included in separate computing devices that are communicatively coupled.

The processing device 202 can include one processing device or multiple processing devices. Non-limiting examples of the processing device 202 can include a Field-Programmable Gate Array (FPGA), an application-specific integrated circuit (ASIC), and a microprocessor. The processing device 202 can execute instructions 206 stored in the memory device 204 to perform computing operations. In some examples, the instructions 206 can include processor-specific instructions generated by a compiler or an interpreter from code written in any suitable computer-programming language, such as C, C++, C#, etc.

The memory device 204 can include one memory or multiple memories. The memory device 204 can be non-volatile and may include any type of memory that retains stored information when powered off. Non-limiting examples of the memory device 204 include electrically erasable and programmable read-only memory (EEPROM), flash memory, or any other type of non-volatile memory. At least some of the memory device 204 can include a non-transitory computer-readable medium from which the processing device 202 can read instructions 206. A computer-readable medium can include electronic, optical, magnetic, or other storage devices capable of providing the processing device 202 with computer-readable instructions or other program code. Non-limiting examples of a computer-readable medium include magnetic disk(s), memory chip(s), ROM, random-access memory (RAM), an ASIC, a configured processor, optical storage, or any other medium from which a computer processor can read the instructions 206.

In some examples, the processing device 202 can execute the instructions 206 to perform some or all of the functionality described herein. For example, the processing device 202 can receiving a container layer 203 from a repository 210. The container layer 203 is associated with first metadata 214a indicating a first hash of the container layer 203 and a first identifier of a first user associated with the container layer 203. The processing device 202 can receive a modification 221 to the container layer 203 to generate a modified container layer 222. In response to receiving the modification 221, the processing device 202 can generate second metadata 214b indicating a second hash of the modified container layer 222 and a second identifier of a second user associated with the modified container layer 222. The processing device 202 can control use of the modified container layer 222 based on the first metadata 214a and the second metadata 214b. Because the metadata tracks what modifications are made and who the modifications are made by, the processing device 202 can provide trust-based access and decision making for using the modified container layer 222. As such, modified container layers from restricted locations (e.g., based on their registry) or restricted users can be prohibited from being executed in a container, improving security and regulatory compliance for container execution.

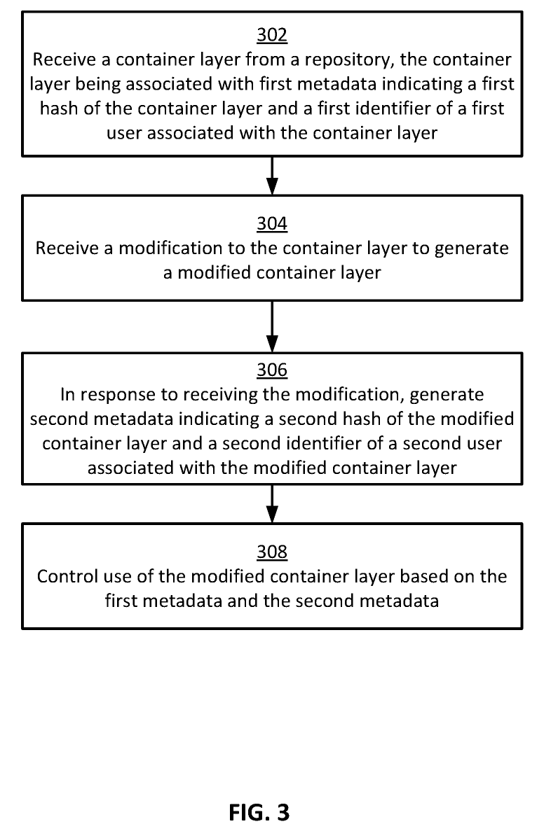

FIG. 3 is a flow chart of an example of a process for container layer lineage for managing software execution according to some examples of the present disclosure. In some examples, the processing device 202 can implement some or all of the steps shown in FIG. 3. Additionally, in some examples, the processing device 202 can be executing on or in communication with the compute node 120 of FIG. 1 to implement some or all of the steps shown in FIG. 3. Other examples can include more steps, fewer steps, different steps, or a different order of the steps than is shown in FIG. 3. The steps of FIG. 3 are discussed below with reference to the components discussed above in relation to FIGS. 1-2.

At block 302, the processing device 202 can receive a container layer 203 from a repository 210. The container layer 203 is associated with first metadata 214a indicating a first hash 116a of the container layer 203 and a first identifier 118a of a first user associated with the container layer 203. If the container layer 203 has been modified from a previous version of the container layer 203, the first metadata 214a can also include a hash and an identifier associated with each previous version.

At block 304, the processing device 202 can receive a modification 221 to the container layer 203 to generate a modified container layer 222. The modification 221 can include a change to contents of the container layer 203. For instance, the modification 221 may include a change to a version of a software application included in the container layer 203, a change of the software application that is included in the container layer 203 (e.g., from a first software application to a second software application), a change of an environment used to execute a software application included in the container layer 203, and the like.

At block 306, the processing device 202 can, in response to receiving the modification 221, generate second metadata 214b indicating a second hash 116b of the modified container layer 222 and a second identifier 118b of a second user associated with the modified container layer 222. The second metadata 214b can be stored along with the first metadata 214a in association with the modified container layer 222. That is, when metadata for the modified container layer 222 is accessed or retrieved, both the first metadata 214a and the second metadata 214b are provided. In this way, a lineage and modification history for the modified container layer 222 is provided by the metadata.

At block 308, the processing device 202 can control use of the modified container layer 222 based on the first metadata 214a and the second metadata 214b. For instance, the processing device 202 can determine whether permissions exist for using the modified container layer 222 based on the second identifier 118b or the second hash 116b. If the appropriate permissions exist for the modified container layer 222, then the processing device 202 can execute a container that includes the modified container layer 222. If the permissions do not exist for the modified container layer 222, then the processing device 202 can prevent executing a container that includes the modified container layer 122. Instead, the processing device 202 can execute a container that includes the container layer 203 prior to the modification 221.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

1. A system comprising:
a processing device; and
a memory device including instructions that are executable by the processing device for causing the processing device to perform operations comprising:
receiving a container layer from a repository, the container layer being associated with first metadata indicating a first hash of the container layer and a first identifier of a first user associated with the container layer;
receiving a modification to the container layer to generate a modified container layer;
in response to receiving the modification, generating second metadata indicating a second hash of the modified container layer and a second identifier of a second user associated with the modified container layer; and
controlling use of the modified container layer based on the first metadata and the second metadata.

2. The system of claim 1, wherein controlling the use of the modified container layer comprises:
determining whether a first permission exists to use the modified container layer based on the second identifier; and
controlling the use of the modified container layer based on whether the first permission exists.

3. The system of claim 2, wherein the operations further comprise:
determining a presence of the first permission to use the modified container layer based on the second identifier; and
in response to determining the presence of the first permission, execute a container using the modified container layer.

4. The system of claim 2, wherein the operations further comprise:
determining a lack of the first permission to use the modified container layer based on the second identifier;
determining a presence of a second permission to use the container layer based on the first identifier; and
in response to determining the lack of the first permission and the presence of the second permission, execute a container using the container layer.

5. The system of claim 1, wherein controlling the use of the modified container layer comprises:
determining whether a third permission exists to use the modified container layer based on the second hash; and
controlling the use of the modified container layer based on whether the third permission exists.

6. The system of claim 1, wherein the modification is a first modification, the modified container layer is a first modified container layer, and wherein the operations further comprise:
receiving a second modification to the container layer to generate a second modified container layer;
in response to receiving the second modification, generating third metadata indicating a third hash of the second modified container layer and a third identifier of a third user associated with the second modified container layer;
determining that the third hash matches the second hash; and
in response to determining that the third hash matches the second hash, deduplicating storage of the first modified container layer and the second modified container layer.

7. The system of claim 1, wherein the operations further comprise:
determining a type of the modification based on the second hash; and
preventing an execution of a container using the modified container layer based on the type of the modification.

8. A method comprising:
receiving a container layer from a repository, the container layer being associated with first metadata indicating a first hash of the container layer and a first identifier of a first user associated with the container layer;
receiving a modification to the container layer to generate a modified container layer;
in response to receiving the modification, generating second metadata indicating a second hash of the modified container layer and a second identifier of a second user associated with the modified container layer; and
controlling use of the modified container layer based on the first metadata and the second metadata.

9. The method of claim 8, wherein controlling the use of the modified container layer comprises:
determining whether a first permission exists to use the modified container layer based on the second identifier; and
controlling the use of the modified container layer based on whether the first permission exists.

10. The method of claim 9, further comprising:
determining a presence of the first permission to use the modified container layer based on the second identifier; and
in response to determining the presence of the first permission, execute a container using the modified container layer.

11. The method of claim 9, further comprising:
determining a lack of the first permission to use the modified container layer based on the second identifier;
determining a presence of a second permission to use the container layer based on the first identifier; and
in response to determining the lack of the first permission and the presence of the second permission, execute a container using the container layer.

12. The method of claim 8, wherein controlling the use of the modified container layer comprises:
determining whether a third permission exists to use the modified container layer based on the second hash; and
controlling the use of the modified container layer based on whether the third permission exists.

13. The method of claim 8, wherein the modification is a first modification, the modified container layer is a first modified container layer, and wherein the method further comprises:
receiving a second modification to the container layer to generate a second modified container layer;
in response to receiving the second modification, generating third metadata indicating a third hash of the second modified container layer and a third identifier of a third user associated with the second modified container layer;
determining that the third hash matches the second hash; and
in response to determining that the third hash matches the second hash, deduplicating storage of the first modified container layer and the second modified container layer.

14. The method of claim 8, further comprising:
determining a type of the modification based on the second hash; and
preventing an execution of a container using the modified container layer based on the type of the modification.

15. A non-transitory computer-readable medium comprising program code that is executable by a processor for causing the processor to perform operations including:
receiving a container layer from a repository, the container layer being associated with first metadata indicating a first hash of the container layer and a first identifier of a first user associated with the container layer;
receiving a modification to the container layer to generate a modified container layer;
in response to receiving the modification, generating second metadata indicating a second hash of the modified container layer and a second identifier of a second user associated with the modified container layer; and
controlling use of the modified container layer based on the first metadata and the second metadata.

16. The non-transitory computer-readable medium of claim 15, wherein controlling the use of the modified container layer comprises:
determining whether a first permission exists to use the modified container layer based on the second identifier; and
controlling the use of the modified container layer based on whether the first permission exists.

17. The non-transitory computer-readable medium of claim 16, wherein the operations further comprise:
determining a presence of the first permission to use the modified container layer based on the second identifier; and
in response to determining the presence of the first permission, execute a container using the modified container layer.

18. The non-transitory computer-readable medium of claim 16, wherein the operations further comprise:
determining a lack of the first permission to use the modified container layer based on the second identifier;
determining a presence of a second permission to use the container layer based on the first identifier; and
in response to determining the lack of the first permission and the presence of the second permission, execute a container using the container layer.

19. The non-transitory computer-readable medium of claim 15, wherein controlling the use of the modified container layer comprises:
determining whether a third permission exists to use the modified container layer based on the second hash; and
controlling the use of the modified container layer based on whether the third permission exists.

20. The non-transitory computer-readable medium of claim 15, wherein the modification is a first modification, the modified container layer is a first modified container layer, and wherein the operations further comprise:
receiving a second modification to the container layer to generate a second modified container layer;
in response to receiving the second modification, generating third metadata indicating a third hash of the second modified container layer and a third identifier of a third user associated with the second modified container layer;
determining that the third hash matches the second hash; and
in response to determining that the third hash matches the second hash, deduplicating storage of the first modified container layer and the second modified container layer.
